(19) United States
(12) Patent Application Publication
(10) Pub. No.: US 2022/0405981 A1
(43) Pub. Date: Dec. 22, 2022

(54) DECODING METHOD, ENCODING METHOD, DECODING APPARATUS AND PROGRAM

(71) Applicant: NIPPON TELEGRAPH AND TELEPHONE CORPORATION, Tokyo (JP)

(72) Inventors: Mayuko WATANABE, Tokyo (JP); Ryuichi TANIDA, Tokyo (JP); Hideaki KIMATA, Tokyo (JP)

(73) Assignee: NIPPON TELEGRAPH AND TELEPHONE CORPORATION, Tokyo (JP)

(21) Appl. No.: 17/779,533

(22) PCT Filed: Nov. 26, 2019
(86) PCT No.: PCT/JP2019/046240

§ 371 Date: May 24, 2022

(51) Int. Cl. G06T 9/40

(52) U.S. Cl. CPC G06T 9/40

(57) ABSTRACT

A decoding method executed by a decoding device for decoding encoded data from point cloud data includes: acquiring an occupancy code represented in an N (1≤N≤8)-ary tree structure by decoding the encoded data; repeating a process of generating an N-ary tree structure until a block has a predetermined size, the process being a process in which a cube configured to include all the point cloud data is divided into eight blocks and thereafter when a bit of an occupancy code corresponding to a divided block is 1, the block is further divided; and acquiring, as coordinates of a point in the point cloud data, coordinates of a block of the predetermined size where a bit of an occupancy code corresponding to the block of the predetermined size is 1. In the repeating, the decoding device determines a value of N of the N-ary tree structure for a block to be divided on a basis of an inclusion relation between the block to be divided and a non-occupancy region set in advance.

### TECHNICAL FIELD

The present invention relates to coding and decoding of point cloud data.

### BACKGROUND ART

Currently, standardization of point cloud data compression (PCC: Point Cloud Compression) is under progress. Regarding PCC, standardization is under progress in both video based compression (V-PCC) and geometry based compression (G-PCC).

In the G-PCC in progress disclosed in NPL 1, point cloud data is encoded using an octree structure.

More specifically, first, a cube B (bounding box) including all point cloud data of the coding object is defined, and the cube B is divided into eight blocks.

1 is assigned to a divided block including a point, and 0 is assigned to a divided block including no point, and thus an 8-bit code (occupancy code) is generated. Occupancy codes for all point cloud data is obtained by repeating a process of further dividing the block assigned with 1 into eight pieces and assigning 0/1 thereto until the block has a predetermined size.

### CITATION LIST

### Non Patent Literature

NPL 1: Information technology-MPEG-I (Coded Representation of Immersive Media)-Part 9: Geometry-based Point Cloud Compression, ISO/IEC 23090-9:2019 (E), ISO/IEC JTC 1/SC 29/WG 11

### SUMMARY OF THE INVENTION

### Technical Problem

However, considering the presence of points in point cloud data acquired in a real space, there are many regions where no object is present, such as a space surrounded by walls and a road, and a space at a predetermined height or greater from the floor in a common office.

Therefore, in coding using the above-mentioned known octree structure, the block is often formed to include the boundary between the region where an object is present and the region where no object is present. Consequently, the occupancy state of a block including a region where no object is present is often represented in the 8-bit code, thus resulting in a large number of wasteful codes.

In view of the above-described points, an object of the present invention is to provide a technique of reducing the amount of code in coding or decoding of point cloud data using an octree structure.

### Means for Solving the Problem

According to the technique of the disclosure, a decoding method executed by a decoding device for decoding encoded data from point cloud data is provided. The decoding method includes acquiring an occupancy code represented in an N (1≤N≤8)-ary tree structure by decoding the encoded data; repeating a process of generating an N-ary tree structure until a block has a predetermined size, the process being a process in which a cube configured to include all the point cloud data is divided into eight blocks and thereafter when a bit of an occupancy code corresponding to a divided block is 1, the block is further divided; and acquiring, as coordinates of a point in the point cloud data, coordinates of a block of the predetermined size where a bit of an occupancy code corresponding to the block of the predetermined size is 1. In the repeating, the decoding device determines a value of N of the N-ary tree structure for a block to be divided on a basis of an inclusion relation between the block to be divided and a non-occupancy region set in advance.

### Effects of the Invention

According to the technique of the disclosure, it is possible to provide a technique of reducing the amount of code in coding or decoding of point cloud data using an octree structure.

### BRIEF DESCRIPTION OF DRAWINGS

FIG. 1 is a diagram illustrating an example of a block including all point cloud data.

FIG. 2 is a diagram illustrating an image of recursively dividing a block into eight pieces.

FIG. 3 is a diagram illustrating an example of positions of divided blocks.

FIG. 4 is a diagram illustrating an example of a configuration of a system in an embodiment of the present invention.

FIG. 5 is a diagram illustrating a configuration of a coding device.

FIG. 6 is a diagram illustrating a configuration of a decoding device.

FIG. 7 is a diagram illustrating an example of a hardware configuration of a device.

FIG. 8 is a flowchart for describing an operation of the coding device.

FIG. 9 is a flowchart for describing an operation of the coding device.

FIG. 10 is a flowchart for describing an operation of the coding device.

FIG. 11 is a diagram illustrating an example of a non-occupancy region.

FIG. 12 is a diagram illustrating an example 1 of a positional relationship between a non-occupancy region and a block.

FIG. 13 is a diagram illustrating an example 2 of a positional relationship between a non-occupancy region and a block.

FIG. 14 is a diagram illustrating an example 3 of a positional relationship between a non-occupancy region and a block.

FIG. 15 is a diagram illustrating an example of a case where a region including one vertex A is excluded.

FIG. 16 is a diagram illustrating an example of a case where a region including two vertexes A and B is excluded.

FIG. 17 is a diagram illustrating an example of a case where a region including four vertexes A, B, C and D is excluded.

FIG. 18 is a diagram illustrating the occurrence probability at each number of bits.

FIG. 19 is a flowchart for describing an operation of a decoding device.

### DESCRIPTION OF EMBODIMENTS

An embodiment of the present invention is described below with reference to the accompanying drawings. The embodiment described below is merely an example, and embodiments to which the present invention is applied are not limited to the following embodiment.

Octree Structure

In order to make the technology easier to understand, the way of representing the occupancy state of point cloud data using the octree structure in the case where the technology according to the present invention is not used is described first.

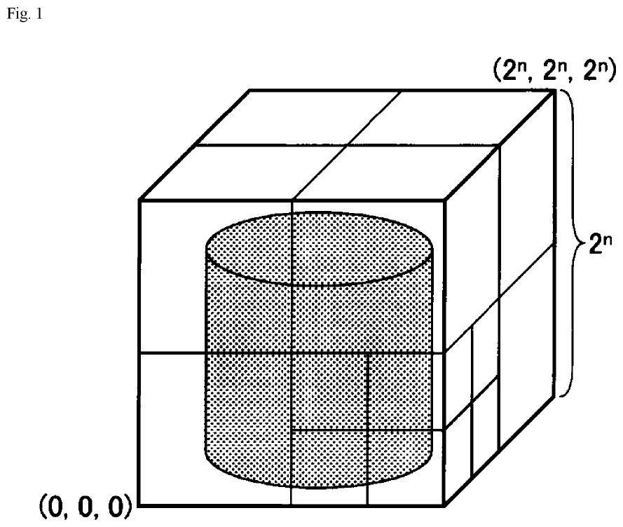

First, a cube B (bounding box) including all point cloud data of the coding object is defined. As illustrated in FIG. 1, the cube B can be defined with the origin (0, 0, 0) of the coordinates and a point (2ⁿ, 2ⁿ, 2ⁿ) farthest from the origin (0, 0, 0). In addition, a translation coordinate conversion is performed on the point cloud data to include it in the cube B in such a manner that the minimum value of each of x, y and z of the point cloud data is 0.

Next, the cube B is divided into eight cubes in such a manner that each side of the cube B becomes ½. The divided cube may be referred to as sub cube, block and the like. In the following description, “block” is mainly used.

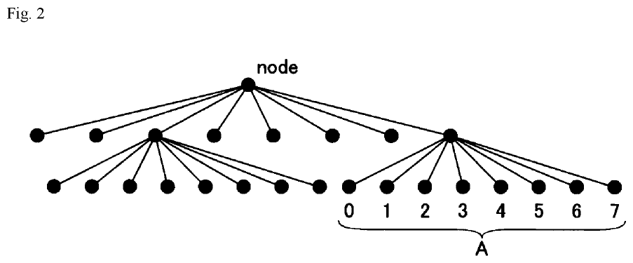

A structure obtained by dividing a cube (or a block) into N (1≤N≤8) pieces is referred to as N-ary tree structure. The “N-ary tree structure” may be a block structure obtained by dividing a cube (or a block) into N pieces, or may be a bit string in which a bit is assigned to a node at an end of each of a plurality of branches extending from a node as illustrated in FIG. 2 described later.

When a point is present in a divided block, 1 is assigned to that block, and when no point is present, 0 is assigned to that block. Thus, an 8-bit code (referred to as occupancy code) is generated. The process of further dividing the block assigned with 1 into eight pieces and assigning 0/1 thereto is repeated until the block has a predetermined size (e.g., 1), and thus an occupancy code representing all point cloud data in the octree structure is obtained.

A block in a predetermined size including a point may be referred to as voxel. Note that while one point is included in a block in a predetermined size in the present embodiment, a plurality of points may be included in a block in a predetermined size. In such a case, for example, the information about the number of points is encoded. During decoding, the number of points in the block can be obtained by decoding the encoded information.

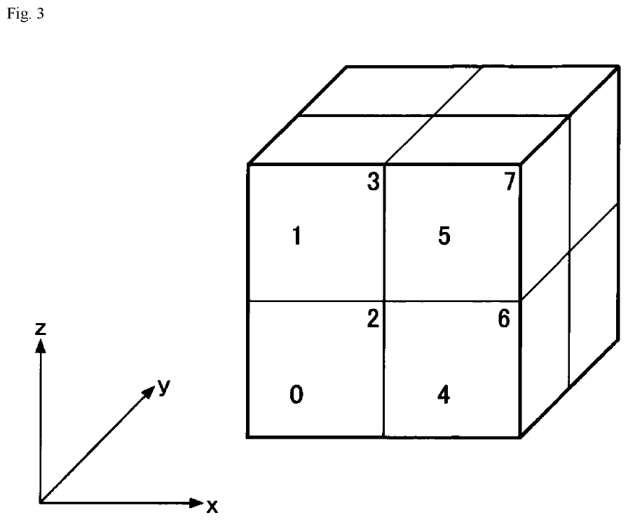

FIG. 2 illustrates an example of an octree structure of a state after two 8-divisions. As illustrated in FIG. 2, each point (cube, block) in an octree structure is referred to as node. The numbers 1 to 7 in “A” of FIG. 2 indicate a correspondence relationship between the block position and the bit position in eight bits corresponding to eight blocks obtained by dividing a certain block into eight pieces. For example, the leftmost “0” in the eight bits illustrated in “A” represents the block closest to the origin in the example of the block illustrated in FIG. 3. Note that in FIG. 3, the upper left block on the front side is 1, the block below 1 is 0, the upper right block on the front side is 5, and the block below 5 is 4. The upper left block on the rear side is 3, the block below 3 is 2, the upper right block on the rear side is 7, and the block below 7 is 6.

As described above, in eight bits representing eight blocks obtained by dividing a certain cube (block), the bit of the block including a point is 1, and the bit of the block including no point is 0. In the representation of the occupancy state with the octree structure (which may be referred to as coding), eight bits having 0/1 are represented by the numeric values of 0 to 255.

For example, eight bits of (1, 1, 0, 0, 0, 0, 0, 0) are represented by 3, and eight bits of (1, 1, 1, 1, 1, 1, 1, 1) are represented by 255. When the representation of eight bits with the numeric values of 0 to 255 is set as function f, it can be expressed by the following equation. Note that in the following equation, Σ represents a sum based on k=0 to 7.

f(x₀,x₁,x₂,x₃,x₄,x₅,x₆,x₇)=Σxₖ2^{k}

After the conversion into the numeric values 0 to 255, the numerical value is subjected to variable-length coding in the order from the higher node. Note that in the embodiment described later, arithmetic coding is used as an example of the variable-length coding. That is, in the present embodiment, variable-length coding other than the arithmetic coding may be used.

As described above, due to the nature of point cloud data acquired in a real space, when the occupancy state is represented using a known octree structure, a block is often located at the boundary between the region where an object is present and the region where it is not present, and the occupancy state of a block including a region where no object is present is often represented with the 8-bit code, thus resulting in a large number of wasteful codes. A technique according to the embodiment of the present invention for solving this problem is elaborated below.

System Configuration

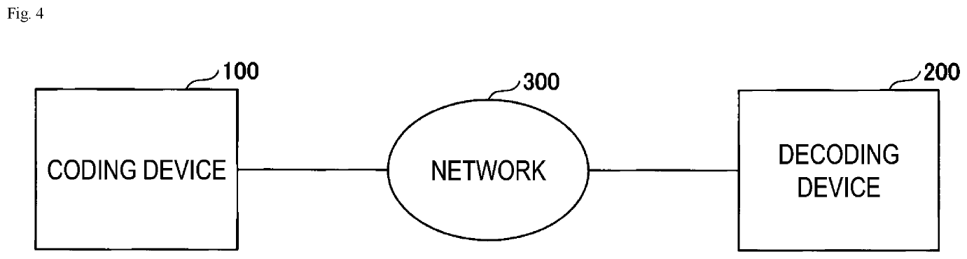

FIG. 4 illustrates an example of an entire configuration of a system according to an embodiment of the present invention. As illustrated in FIG. 4, this system includes a coding device 100 and a decoding device 200, and has a configuration in which the coding device 100 and the decoding device 200 are connected to each other through a network 300.

Point cloud data (coordinates of each point) as a coding object are input to the coding device 100. The coding device 100 encodes the point cloud data, and transmits the encoded data to the decoding device 200 through the network 300.

The decoding device 200 receives the encoded data from the coding device 100, decodes the encoded data to obtain the original point cloud data, and outputs the data.

Note that the communication through the network 300 in the above-described manner is an example. For example, the point cloud data may be obtained by recording the encoded data encoded at the coding device 100 in a recording medium, bringing the recording medium offline to the decoding device 200, reading the encoded data from the recording medium at the decoding device 200, and decoding the data.

Device Configuration

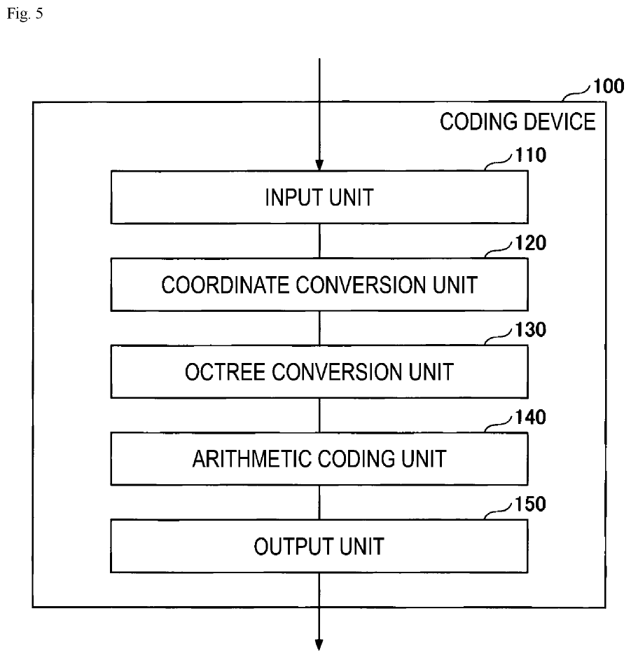

FIG. 5 illustrates an example of a functional configuration of the coding device 100. As illustrated in FIG. 5, the coding device 100 includes an input unit 110, a coordinate conversion unit 120, an octree conversion unit 130, an arithmetic coding unit 140, and an output unit 150.

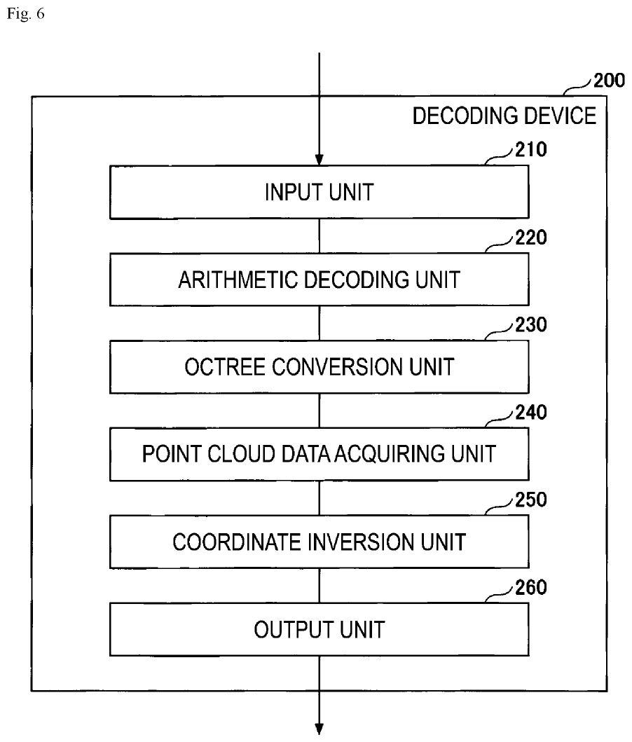

FIG. 6 illustrates an example of a functional configuration of the decoding device 200. As illustrated in FIG. 6, the decoding device 200 includes an input unit 210, an arithmetic decoding unit 220, an octree conversion unit 230, a point cloud data acquiring unit 240, a coordinate inversion unit 250, and an output unit 260. Note that the arithmetic decoding unit 220, the octree conversion unit 230, and the point cloud data acquiring unit 240 may be referred to as a decoding unit, a conversion unit, and an acquiring unit, respectively.

Note that the function of the decoding device 200 may be further provided in the coding device 100. In addition, the function of the coding device 100 may be further provided in the decoding device 200. The operation of each unit in the coding device 100 and the decoding device 200 is elaborated in descriptions of operations later.

Example of Hardware Configuration

Each of the coding device 100 and the decoding device 200 can be implemented by, for example, causing a computer to execute programs describing the processing content described in the present embodiment. Note that “computer” may be a virtual machine in the cloud. In the case where a virtual machine is used, the “hardware” described herein is virtual hardware.

The program can be recorded on a computer-readable recording medium (a portable memory or the like) to be stored or distributed. The program can also be provided via a network such as the Internet or an electronic mail.

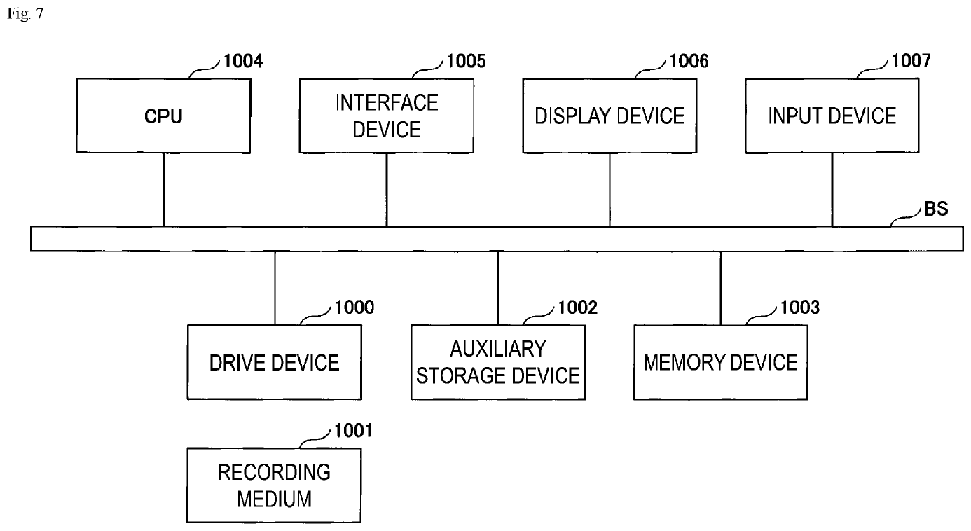

FIG. 7 illustrates an example of a hardware configuration of the above-mentioned computer. The computer illustrated in FIG. 7 includes a drive device 1000, an auxiliary storage device 1002, a memory device 1003, a CPU 1004, an interface device 1005, a display device 1006, an input device 1007, and the like, which are mutually connected through a bus BS.

A program for implementing processing in the computer is provided by, for example, a recording medium 1001 such as a CD-ROM or a memory card. When the recording medium 1001 that stores a program is set in the drive device 1000, the program is installed in the auxiliary storage device 1002 from the recording medium 1001 via the drive device 1000. Here, the program may not necessarily be installed from the recording medium 1001 and may be downloaded from another computer via a network. The auxiliary storage device 1002 stores the installed program and also stores necessary files, data, and the like.

The memory device 1003 reads the program from the auxiliary storage device 1002 and stores the program in a case where an instruction to start the program is given. The CPU 1004 implements the function of the device in accordance with the program stored in the memory device 1003. The interface device 1005 is used as an interface for connection to a network. The display device 1006 displays a graphical user interface (GUI) or the like according to a program. The input device 1007 is constituted by a keyboard, a mouse, buttons, a touch panel, or the like, and is used to input various operation instructions.

Example of Operation of Coding Device 100

Next, an example of an operation of the coding device 100 is described. Note that while the coding of point cloud data includes the coding related to the point position and the coding related to the attributes such as the point color, the present embodiment pays attention to the coding related to the point position.

While the coding device 100 basically performs coding of the occupancy state using the above-described octree structure, the coding device 100 achieves a representation of the occupancy state in trees with a number less than 8 by preliminarily excluding a region where no point (object) is present (referred to as non-occupancy region) from the cube B and omitting the coding of the occupancy state of the point in the excluded region, to solve the above-described problem. Note that the non-occupancy region may include a boundary between a region where no point is present and a region where a point is present.

While information representing the non-occupancy region to be excluded becomes an increase as overhead, the amount of code can be reduced because it is only necessary to encode a code including no point in the non-occupancy region without the need for representing the non-occupancy region in octree, and the occupancy state that has been entirely represented in octree can be partially represented in trees with a number less than 8.

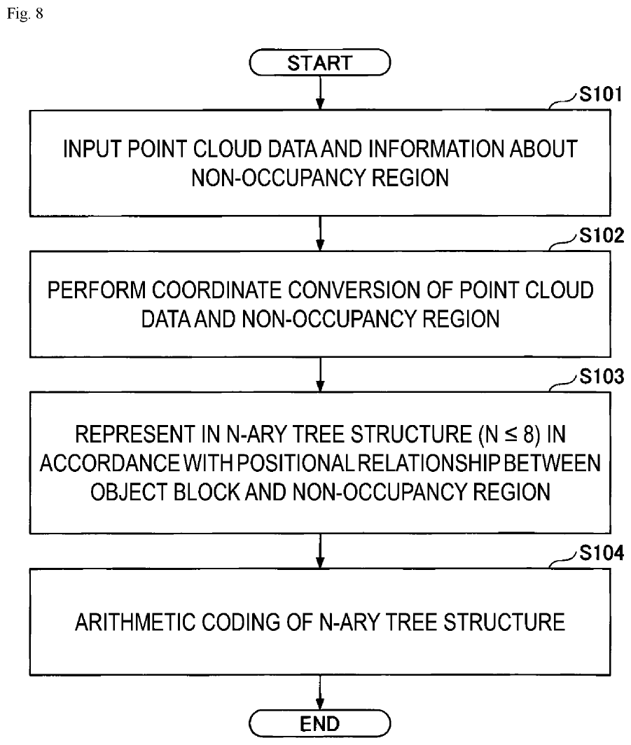

An example of an operation of the coding device 100 is elaborated below with reference to flowcharts of FIGS. 8 to 10.

Entire Operation of Coding Device 100

The entire operation of coding device 100 is described below with reference to the flowchart of FIG. 8.

First, as a preliminary preparation, the region to be excluded as a non-occupancy region is determined from the space including the three-dimensional shape represented by the point cloud data of the coding object. While an example where only one non-occupancy region is excluded is illustrated below, a plurality of non-occupancy regions may be determined to be excluded.

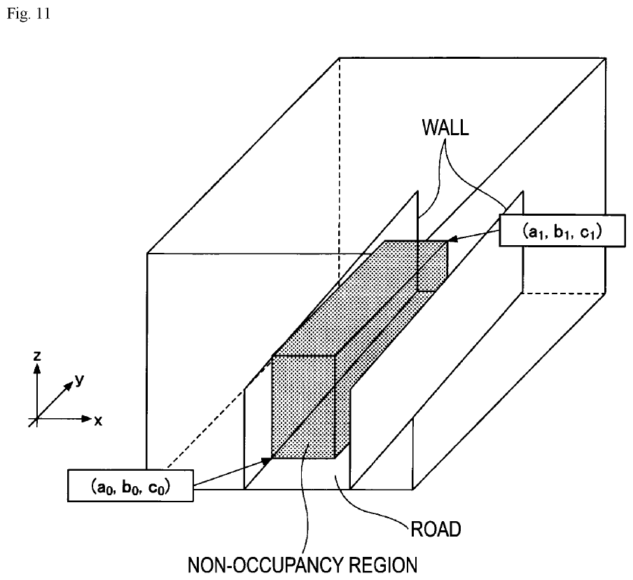

FIG. 11 is a diagram illustrating an example of a non-occupancy region. Note that FIG. 11 illustrates coordinates after the coordinate conversion described later is performed, for convenience. In the example illustrated in FIG. 11, the region including nothing above the road between the walls on the both sides is the non-occupancy region. While the non-occupancy region has a cuboid shape with surfaces parallel to the surfaces of the cube B in the present embodiment, this is merely an example, and the non-occupancy region may have any shapes and orientations. It should be noted that, desirably, the non-occupancy region has a shape that can be represented by an amount of code (the above-described overhead) smaller than the amount of code of the occupancy code that can be omitted by excluding the non-occupancy region.

In FIG. 11, the coordinates of the point closest to the origin in the non-occupancy region is (a₀, b₀, c₀), and the coordinates of the point farthest from the origin is (a₁, b₁, c₁). Accordingly, no point is present at (x, y, z) that meets a₀≤x≤a₁ ∧b₀≤y≤b₁ ∧c₀≤z≤c₁.

S101

At S101 in FIG. 8, point cloud data (a set of three-dimensional coordinates of points) as a coding object and information about a non-occupancy region (e.g., the coordinates of the point closest to the origin and the coordinates of the point farthest from the origin) are input from the input unit 110.

S102

At S102, the coordinate conversion unit 120 generates the cube B (bounding box), and performs coordinate conversion of the input point cloud data in the same manner as the above-described case where a known octree structure is used. In addition, the coordinate conversion unit 120 performs the same coordinate conversion as the coordinate conversion of the point cloud data also for the coordinates of the non-occupancy region.

S103

At S103, the octree conversion unit 130 generates the occupancy code in the order from the higher node by performing the conversion into an octree structure on the cube B including the point cloud data.

Specifically, first, the octree conversion unit 130 generates eight blocks by dividing the cube B into eight pieces, and generates an 8-bit occupancy code by assigning 1 to a divided block including a point while assigning 0 to a block including no point. The octree conversion unit 130 generates the occupancy code of each of nodes from the highest node to the lowest node by repeating a process of further dividing the block assigned with 1 and assigning 0/1 thereto until the block has a predetermined size.

In the present embodiment, in the block dividing process that recursively proceeds in the above-described manner, the octree conversion unit 130 represents the occupancy state of each block in an N-ary tree structure (1≤N≤8) in accordance with the positional relationship between the block and the non-occupancy region. Note that in the case where N is 8, it is the same as the representation in the existing octree structure. The details of S103 are described later.

S104

At S104, the arithmetic coding unit 140 performs arithmetic coding on the numerical value indicating the occupancy code represented in the N-ary tree structure generated at S103 (e.g., in the case of octree, any numeric value of 0 to 255). Note that the numerical value indicating the occupancy code may also be referred to as occupancy code. The output unit 150 transmits the encoded data obtained through the arithmetic coding to the decoding device 200.

S104 may be performed every time when the occupancy code represented in the N-ary tree structure is generated, or every time when a plurality of the occupancy codes represented in the N-ary tree structure is generated, at S103.

Note that the information transmitted from the coding device 100 to the decoding device 200 includes information representing a non-occupancy region in addition to information that is typically sent in point cloud coding.

Details of S103

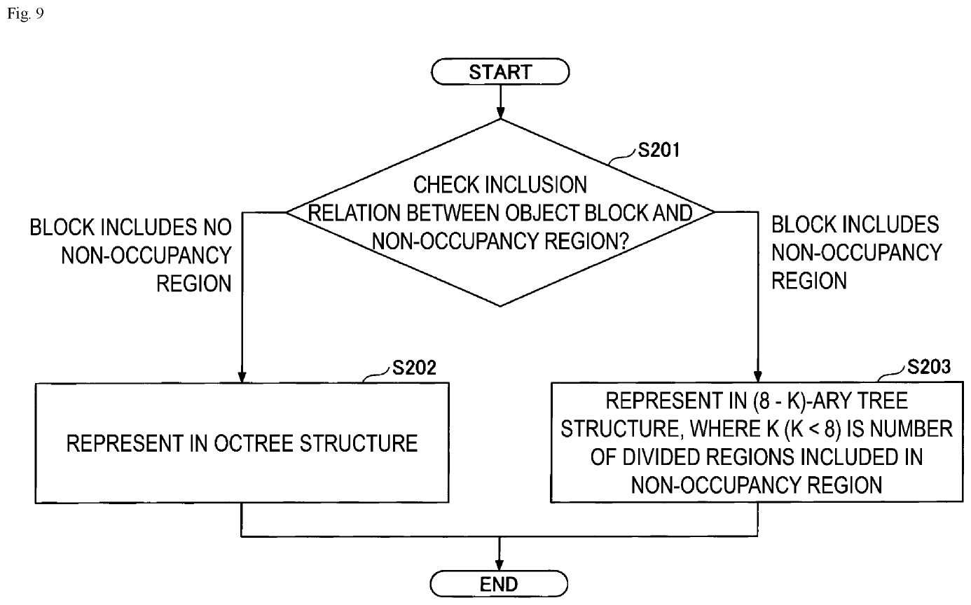

As described in S103, in the block dividing process that recursively proceeds, the octree conversion unit 130 represents the occupancy state of each block in the N-ary tree structure (1≤N≤8) in accordance with the positional relationship between the block and the non-occupancy region. Details of the process of S103 for a certain block are described with reference to the flowchart of FIG. 9.

At S201, when it is determined that the block includes no non-occupancy region, the process proceeds to S202, and the octree conversion unit 130 represents the occupancy state of the block in the octree structure.

At S201, when it is determined that the block includes a non-occupancy region, the process proceeds to S203. Note that in the case where the entire block is the non-occupancy region, the process does not proceed to S203. The reason for this that it is 0 at the upper level of the octree, and is not the coding object in the first place.

At S203, in the case where the object block is divided into eight pieces, the octree conversion unit 130 determines the number k (1<k<8) of the divided regions included in the non-occupancy region, and represents the occupancy state of the object block in a (8−k)-ary tree structure.

An example of a method of determining the positional relationship between the block and the non-occupancy region is described below. The octree conversion unit 130 determines the positional relationship between the non-occupancy region (cuboid) and the block by comparing (x₀, y₀, z₀)((min x, min y, min z)(the vertex closest to the origin), (x₁, y₁, z₁)((max x, max y, max z))(the vertex farthest from the origin) and (a₀, a₁, b₀, b₁, c₀, c₁) for a point (x, y, z) in the block.

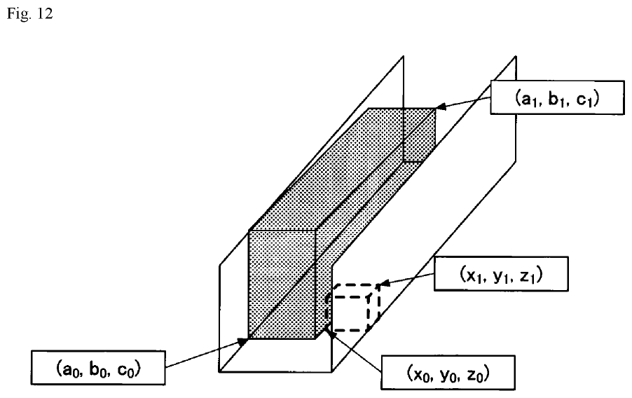

In the case where “(x₁<a₀ ∨x₀>a₁)∨(y₁<b₀ ∨y₀>b₁)∨(z₁<c₀ ∨z₀>c₁)” holds as a result of the comparison, it is determined that the block includes no non-occupancy region at all. An example of this case is illustrated in FIG. 12.

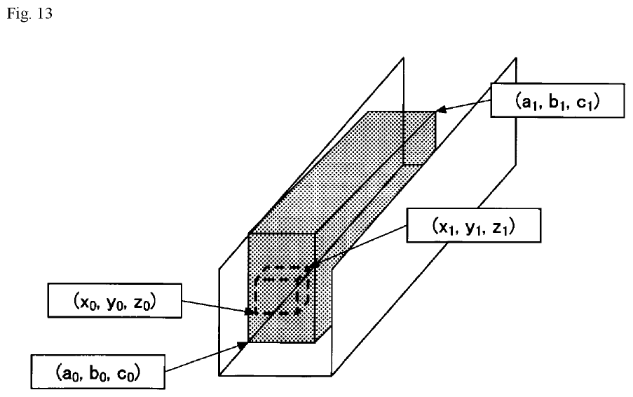

In the case where “(x₁≤a₁ ∧x₀≥a₀)∧(y₁≤b₁ ∧y₀≥b₀)∧(z₁≤c₁ ∧z₀≥c₀)” holds, it is determined that the block is completely included in the non-occupancy region. An example of this case is illustrated in FIG. 13.

If none of the above cases apply, it is determined that a part of the block is included in the non-occupancy region. In this case, the octree conversion unit 130 finds out a combination of x₀, y₀, z₀, x₁, y₁ and z₁ that meets “a₀≤x≤a₁ ∧b₀≤y≤b₁ ∧c₀≤z≤c₁”. The number of the combinations is the number of the vertexes included in the non-occupancy region in the block.

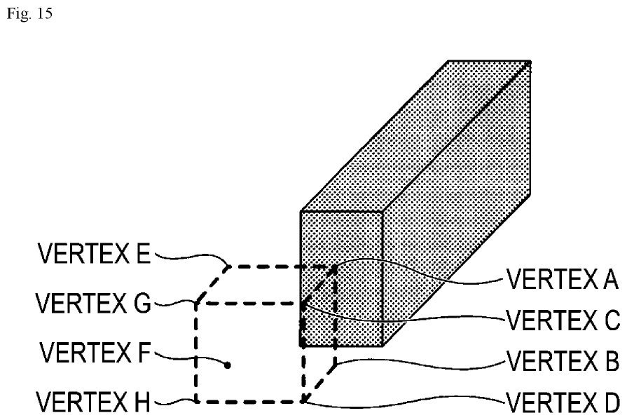

FIG. 15 illustrates an example where “a₀≤x₁≤a₁ ∧b₀≤y₁≤b₁ ∧c₀≤z₁≤c₁” holds, and only one vertex A of the block is included in the non-occupancy region. In the case where this block is divided into eight pieces and the numbers illustrated in FIG. 3 are assigned to the divided regions, the region 7 including the vertex A is the candidate region for exclusion in the example illustrated in FIG. 15.

The octree conversion unit 130 determines whether the length of each side located in the non-occupancy region is not smaller than ½ of the side of the block. In the example illustrated in FIG. 15, the octree conversion unit 130 determines whether ½ or more of each of the side AE, side AC and side AB is included in the non-occupancy region. This is equivalent to a determination whether the region 7 is completely included in the non-occupancy region. In the case where the region 7 is completely included in the non-occupancy region, the octree conversion unit 130 excludes the region 7 from the block, and represents the occupancy state in the 7-ary tree structure (i.e., the 7-bit code). In the case where the region 7 is not completely included in the non-occupancy region, the octree conversion unit 130 represents the occupancy state in the octree structure (i.e., the 8-bit code) without excluding the region 7 from the block.

Note that the configuration of excluding the candidate region for exclusion in the case where the candidate region is completely included in the non-occupancy region is merely an example. For example, it is possible to adopt a configuration in which the candidate region for exclusion is excluded in the case where a part (e.g., K % of the region (e.g., K is 90) or greater) of the candidate region is included in the non-occupancy region.

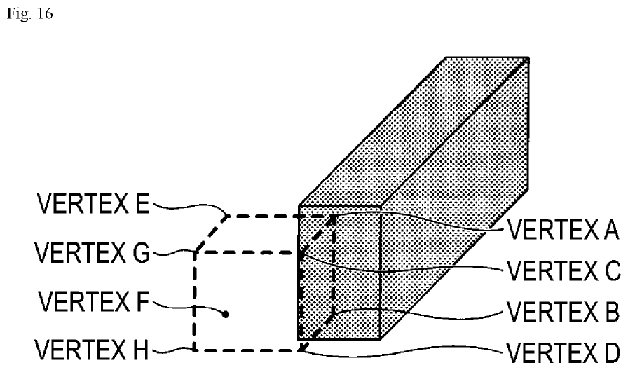

FIG. 16 illustrates an example where “a₀≤x₁≤a₁ ∧b₀≤y₁≤b₁ ∧c₀≤z₁≤c₁” and “a₀≤x₁≤a₁ ∧b₀≤y₁≤b₁ ∧c₀≤z₀≤c₁” hold, and two vertexes of the block, the vertex A and vertex B, are included in the non-occupancy region. In the case where this block is divided into eight pieces and the numbers illustrated in FIG. 3 are assigned to the divided regions, the region 7 including the vertex A and the region 6 including the vertex B are the candidate regions for exclusion in the example illustrated in FIG. 16.

The octree conversion unit 130 determines whether the length of each side located in the non-occupancy region is not smaller than ½ of the side of the block. In the example illustrated in FIG. 16, the octree conversion unit 130 determines whether ½ or more of each of the side AE, side AC, side BF and side BD is included in the non-occupancy region. This is equivalent to a determination whether the region 7 and region 6 are completely included in the non-occupancy region. In the case where the region 7 and region 6 are completely included in the non-occupancy region, the octree conversion unit 130 excludes block the region 7 and region 6, and represents the occupancy state in the 6-ary tree structure (i.e., the 6-bit code). In the case where the region 7 and region 6 are not completely included in the non-occupancy region, the octree conversion unit 130 represents the occupancy state in the octree structure (i.e., the 8-bit code) without excluding the region 7 and region 6 from the block.

Note that the configuration of excluding the candidate regions for exclusion (in this case, “the region 7 and region 6”) in the case where the candidate regions are completely included in the non-occupancy region is merely an example. For example, it is possible to adopt a configuration in which the candidate region for exclusion is excluded in the case where a part (e.g., K % of the region (e.g., K is 90) or greater) of the candidate region is included in the non-occupancy region.

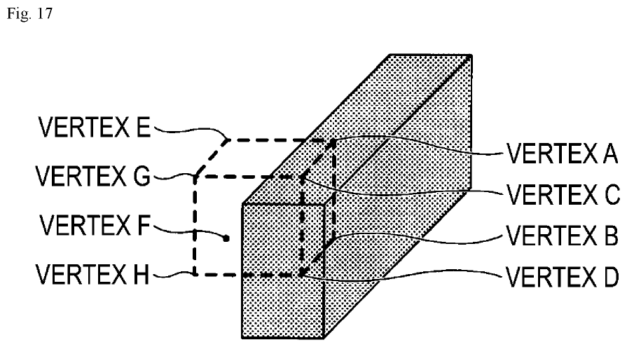

FIG. 17 illustrates an example where “a₀≤x₁≤a₁ ∧b₀≤y₁≤b₁ ∧c₀≤z₁≤c₁”, “a₀≤x₁≤a₁ ∧b₀≤y₁≤b₁ ∧c₀≤z₀≤c₁”, “a₀≤x₁≤a₁∧b₀≤y₀≤b₁ ∧c₀≤z₁≤c₁”, and “a₀≤x₁≤a₁∧b₀≤y₀≤b₁ ∧c₀≤z₀≤c₁” hold, and the four vertexes of the block, the vertex A, vertex B, vertex C and vertex D, are included in the non-occupancy region. In the case where this block is divided into eight pieces and the numbers illustrated in FIG. 3 are assigned to the divided regions, the region 7 including the vertex A, the region 6 including the vertex B, the region 5 including the vertex C and the region 4 including the vertex D are the candidate regions for exclusion in the example illustrated in FIG. 17.

The octree conversion unit 130 determines whether the length of each side located in the non-occupancy region is not smaller than ½ of the side of the block. In the example illustrated in FIG. 17, the octree conversion unit 130 determines whether ½ or more of each of the side AE, side BF, side CG and side DH is included in the non-occupancy region. This is equivalent to a determination whether the region 7, region 6, region 5 and region 4 are completely included in the non-occupancy region. In the case where the region 7, region 6, region 5 and region 4 are completely included in the non-occupancy region, the octree conversion unit 130 excludes the block the region 7, region 6, region 5 and region 4, and represents the occupancy state in the 4-ary tree structure (i.e., the 4-bit code). In the case where “the region 7, region 6, region 5 and region 4” are not completely included in the non-occupancy region, the octree conversion unit 130 represents the occupancy state in the octree structure (i.e., the 8-bit code) without excluding “the region 7, region 6, region 5 and region 4” from the block.

Note that the configuration of excluding the candidate regions for exclusion (in this case, “the region 7, region 6, region 5 and region 4”) in the case where the candidate regions are completely included in the non-occupancy region is merely an example. For example, it is possible to adopt a configuration in which the candidate region for exclusion is excluded in the case where a part (e.g., K % of the region (e.g., K is 90) or greater) of the candidate region is included in the non-occupancy region.

Note that the above-mentioned examples are merely examples. The regions of any number of 1 to 7 may be excluded. That is, in the case where the number of divided regions included in the non-occupancy region in a block is set as k (1<k<8), the occupancy state of that block is represented in the (8−k)-ary tree structure.

Details of S104

As described in S104, the arithmetic coding unit 140 performs arithmetic coding on the numerical value (e.g., in the case of octree, any numeric value of 0 to 255) indicating the occupancy state represented in a N-ary tree structure generated at S103. Details of S104 are described below.

When performing the coding process, the arithmetic coding unit 140 calculates the probability of occurrence of each occupancy code (=each numerical value) indicating the occupancy state, sequentially updates a probability table mapping the numerical value and the generation probability, and accordingly, updates a coding table that is a corresponding table of the numerical value and the codes. The arithmetic coding unit 140 performs the coding using the latest coding table.

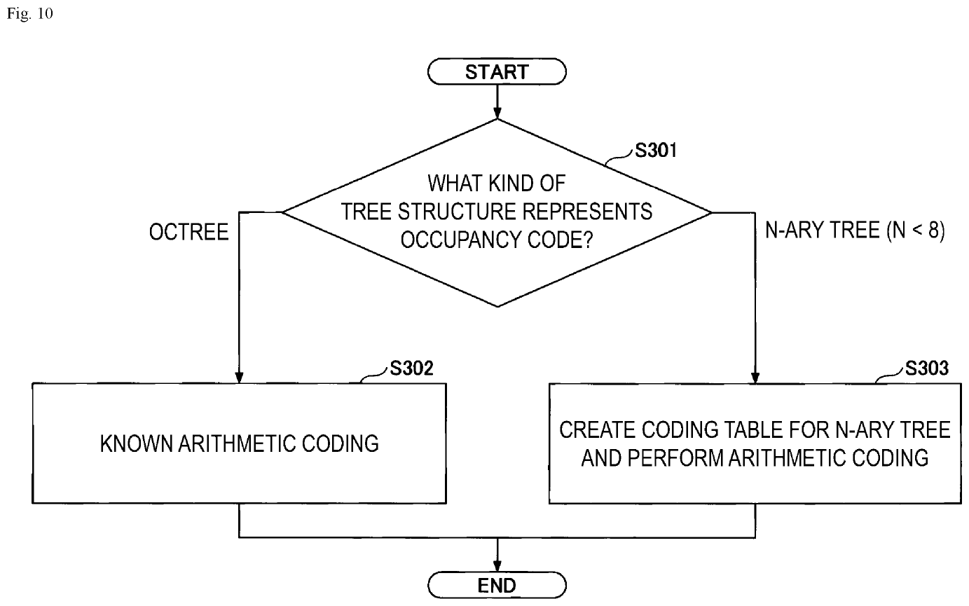

Details of S104 are described with reference to FIG. 10. At S301, the arithmetic coding unit 140 determines what kind of the tree structure represents the occupancy code of the arithmetic coding object, and, in the case of octree, the process proceeds to S302 to perform the same arithmetic coding for the numeric values of 0 to 255 as in known cases.

When it is determined to be N-ary tree (N≤8) at S301, the process proceeds to S303, and the arithmetic coding unit 140 creates a coding table for N-ary tree by generating a probability table for setting the bit of the non-occupancy portion to 0 from the probability table used for the arithmetic coding of the occupancy code in the octree structure, and performs the arithmetic coding using the coding table.

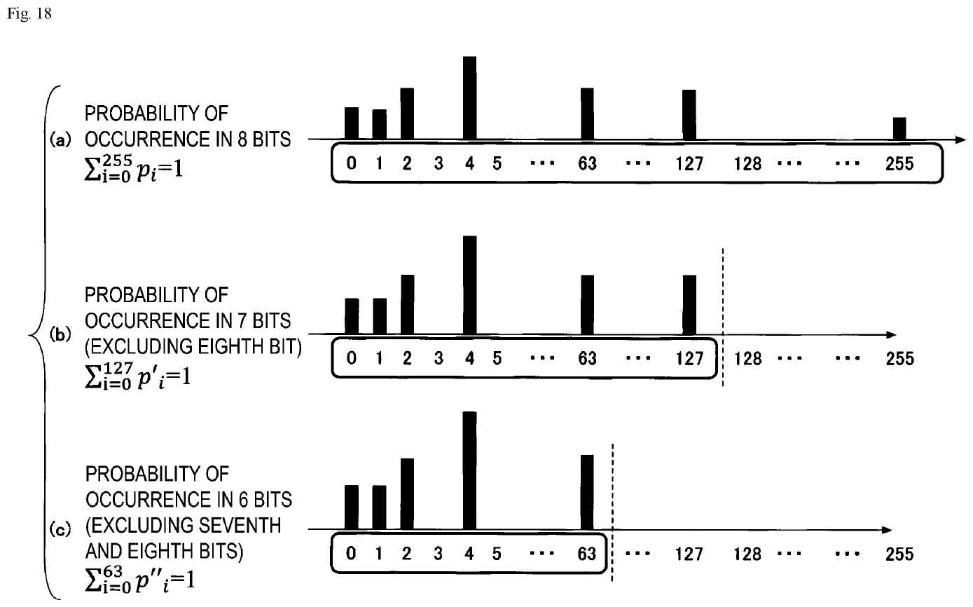

FIG. 18 illustrates a specific example of the process of S303. In FIG. 18, (a) illustrates the probability of occurrence of each numerical value in an 8-bit code (the numeric values of 0 to 255). This corresponds to a probability table of an 8-bit code (the numeric values of 0 to 255). The arithmetic coding unit 140 updates this probability table every time when an 8-bit code is generated.

In the case where the arithmetic coding unit 140 performs arithmetic coding on a numeric value of the code of seven bits (●∘∘∘∘∘∘∘) of eight bits excluding the bit corresponding to the eighth block, for example, and the arithmetic coding unit 140 uses the probability of occurrence of the numerical values corresponding to the 7-bit code in the probability table of the 8-bit code as illustrated in FIG. 18(b). It should be noted that the value of the probability is adjusted such that the sum of the probabilities of 0 to 127 is 1. The arithmetic coding unit 140 generates a coding table for arithmetic coding of the 7-bit code from the probability table illustrated in FIG. 18(b), and performs the arithmetic coding using the table.

In addition, in the case where the arithmetic coding unit 140 performs arithmetic coding on a numeric value of the code of six bits (●●∘∘∘∘∘∘) of eight bits excluding the bits corresponding to the eighth and seventh blocks, for example, and the arithmetic coding unit 140 uses the probability of occurrence of the numerical values corresponding to the 6-bit code in the probability table of the 8-bit code as illustrated in FIG. 18(c). It should be noted that such that it is adjusted such that the sum of the probabilities of 0 to 63 is 1. The arithmetic coding unit 140 generates a coding table for arithmetic coding of the 6-bit code from the probability table illustrated in FIG. 18(c), and performs the arithmetic coding using the table.

Example of Operation of Decoding Device 200

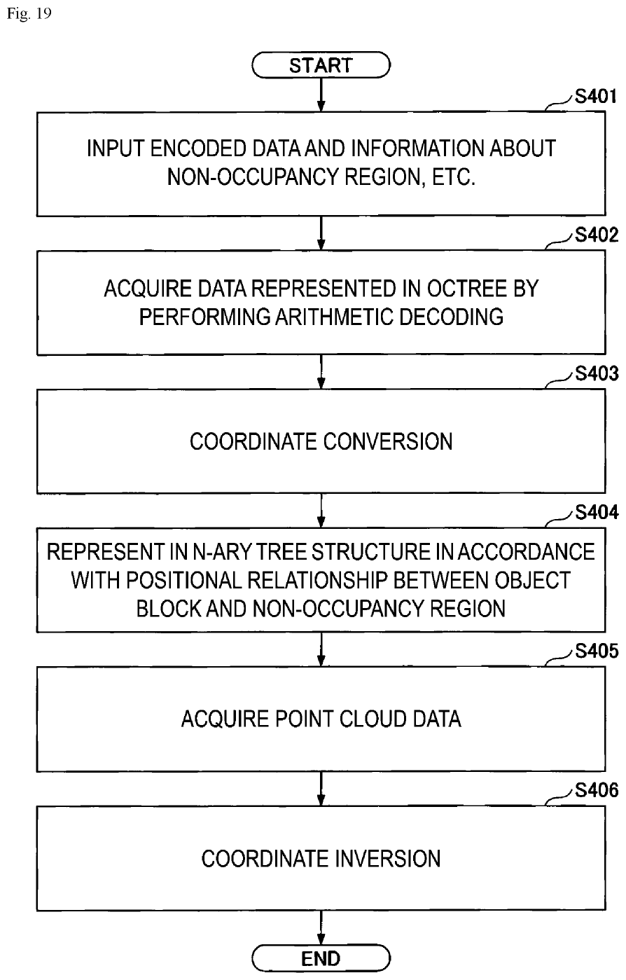

Next, an example of an operation of the decoding device 200 having the configuration illustrated in FIG. 6 is described with reference to the flowchart of FIG. 19. From the coding device 100 to the decoding device 200, encoded data of an arithmetic encoded occupancy code, information representing a non-occupancy region and the like are transmitted in the form of a bit stream. The input unit 210 of the decoding device 200 receives and inputs the bit stream (S401).

At S402, the arithmetic decoding unit 220 acquires an occupancy code represented in a N-ary tree structure (1≤N≤8) by performing arithmetic decoding on the encoded data of the arithmetic encoded occupancy code.

At S403, the octree conversion unit 230 generates the cube B with the same size as in the coding, and performs the same coordinate conversion on the non-occupancy region obtained from the information received from the coding device 100 as in the coding.

At S404, the octree conversion unit 230 performs the conversion into an octree structure on the cube B including the non-occupancy region as in the coding. Then, when the bit of the occupancy code corresponding to the divided block is 1, the process of further dividing the block is repeated until the block has a predetermined size (e.g., 1).

At S405, in the octree structure (a structure obtained by recursively repeating the N-division (N≤8) from the cube B) obtained at S404, the point cloud data acquiring unit 240 acquires, as coordinates of a point in the point cloud data, the coordinates of a block of a predetermined size where bit of the occupancy code corresponding to the block of the predetermined size is 1.

At S406, the coordinate inversion unit 250 obtains the original point cloud data (a set of original coordinates) by performing coordinate conversion opposite to the coordinate conversion for the point cloud data in the coding, on the point cloud data obtained at S405. Thereafter, the output unit 260 displays the obtained point cloud data as an image, for example.

In the conversion into an octree structure in S404 described above, an N-ary tree structure (1≤N≤8) of a block to be divided is determined in accordance with the positional relationship between the block and the non-occupancy region as in the process described for S103 of coding.

The details of the process are the same as those of the process described with FIG. 9, and are therefore described with reference to FIG. 9.

At S201 in FIG. 9, the octree conversion unit 230 determines the inclusion relation between the block to be divided (a certain block whose corresponding occupancy code is 1) and the non-occupancy region.

At S201, when it is determined that the block includes no non-occupancy region, the process proceeds to S202, and the octree conversion unit 230 generates an octree structure by dividing the block into eight pieces.

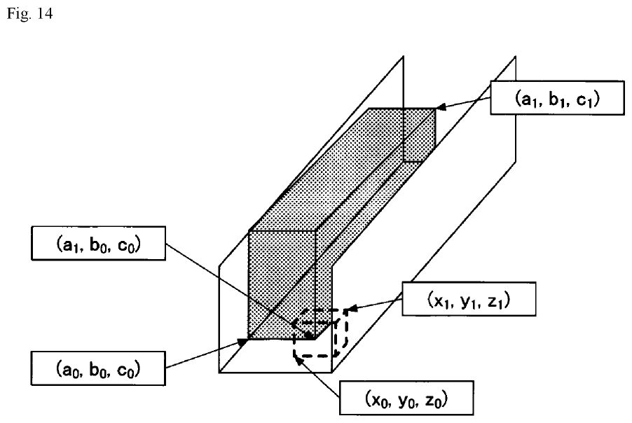

At S201, when it is determined that the block includes a non-occupancy region, the process proceeds to S203. At S203, the octree conversion unit 230 determines the number k (k<8) of divided regions included in the non-occupancy region in the case where the object block is divided into eight pieces, and generates an (8−k)-ary tree structure by excluding k divided regions from the object block divided into eight pieces. In other words, the octree conversion unit 230 determines the value of N of the N-ary tree structure for the block to be divided on the basis of the inclusion relation between the block to be divided and the non-occupancy region. The process of excluding the divided region and the process of determining the inclusion relation between the block and the non-occupancy region in the decoding are the same as those in the coding, and their specific examples are as described with reference to FIGS. 12 to 17.

### Effects of Embodiment and Supplement

As described above, the present embodiment provides a technique of reducing the amount of code in coding or decoding of point cloud data using an octree structure.

The specification describes a decoding method, a coding method, a decoding device, and a program described in at least the following items.

### [First Item]

A decoding method executed by a decoding device for decoding encoded data from point cloud data, the decoding method including:

acquiring an occupancy code represented in an N (1≤N≤8)-ary tree structure by decoding the encoded data;

repeating a process of generating an N-ary tree structure until a block has a predetermined size, the process being a process in which a cube configured to include all the point cloud data is divided into eight blocks and thereafter when a bit of an occupancy code corresponding to a divided block is 1, the block is further divided; and

acquiring, as coordinates of a point in the point cloud data, coordinates of a block of the predetermined size where a bit of an occupancy code corresponding to the block of the predetermined size is 1, wherein

in the repeating, the decoding device determines a value of N of the N-ary tree structure for a block to be divided on a basis of an inclusion relation between the block to be divided and a non-occupancy region set in advance.

### [Second Item]

The decoding method according to the first item, wherein in the repeating, the decoding device determines, as the N, a number obtained by subtracting from 8 a number of divided regions that are entirely or partially included in the non-occupancy region in eight divided regions obtained by dividing the block to be divided into eight pieces.

### [Third Item]

The decoding method according to the first or second item, wherein the non-occupancy region is a region determined to be a region where no object is present in a space including a shape represented by the point cloud data, and the non-occupancy region includes a boundary between a region where no object is present and a region where an object is present.

### [Fourth Item]

A coding method executed by a coding device for encoding point cloud data, the coding method including:

repeatedly executing a process of generating an occupancy code until a size of a block becomes a predetermined size, the process being a process in which after a cube including all the point cloud data is divided into eight blocks, an occupancy code represented in an N (1≤N≤8)-ary tree structure is generated by assigning 1 to a divided block including a point and assigning 0 to a divided block including no point, and the block assigned with 1 is further divided; and

encoding the occupancy code generated by the repeating and outputting the encoded data, wherein

in the repeating, the coding device determines a value of N of the N-ary tree structure for a block to be divided on a basis of an inclusion relation between the block to be divided and a non-occupancy region set in advance.

### [Fifth Item]

A decoding device for decoding point cloud data from encoded data, the decoding device including:

a decoding unit configured to acquire an occupancy code represented in an N (1≤N≤8)-ary tree structure by decoding the encoded data;

a conversion unit configured to repeat a process of generating an N-ary tree structure until a block has a predetermined size, the process being a process in which a cube configured to include all the point cloud data is divided into eight blocks and thereafter when a bit of an occupancy code corresponding to a divided block is 1, the block is further divided; and

an acquiring unit configured to acquire, as coordinates of a point in the point cloud data, coordinates of a block of the predetermined size where a bit of an occupancy code corresponding to the block of the predetermined size is 1, wherein

the conversion unit determines a value of N of the N-ary tree structure for a block to be divided on a basis of an inclusion relation between the block to be divided and a non-occupancy region set in advance.

### [Sixth Item]

A program for causing a computer to function as each of the decoding unit, the conversion unit, the acquiring unit and the conversion unit of the decoding device according to the fifth item.

Although the present embodiment has been described above, the present invention is not limited to such a specific embodiment, and various modifications and changes can be made within the scope of the gist of the present invention described in the claims.

### REFERENCE SIGNS LIST

100 Coding device
110 Input unit
120 Coordinate conversion unit
130 Octree conversion unit
140 Arithmetic coding unit
150 Output unit
200 Decoding device
210 Input unit
220 Arithmetic decoding unit
230 Octree conversion unit
240 Point cloud data acquiring unit
250 Coordinate inversion unit
260 Output unit
300 Network
1000 Drive device
1001 Recording medium
1002 Auxiliary storage device
1003 Memory device
1004 CPU
1005 Interface device
1006 Display device
1007 Input device

1. A decoding method for decoding encoded data from point cloud data, the decoding method comprising:
acquiring an occupancy code represented in an N (1≤N≤8)-ary tree structure by decoding the encoded data;
repeating a process of generating an N-ary tree structure until a block has a predetermined size, the process being a process in which a cube configured to include all the point cloud data is divided into eight blocks and thereafter when a bit of an occupancy code corresponding to a divided block is 1, the block is further divided; and
acquiring, as coordinates of a point in the point cloud data, coordinates of a block of the predetermined size where a bit of an occupancy code corresponding to the block of the predetermined size is 1, wherein
the repeating the process further determines a value of N of the N-ary tree structure for a block to be divided on a basis of an inclusion relation between the block to be divided and a non-occupancy region set in advance.

2. The decoding method according to claim 1, wherein the repeating the process further includes determining, as the N, a number obtained by subtracting from 8 a number of divided regions that are entirely or partially included in the non-occupancy region in eight divided regions obtained by dividing the block to be divided into eight pieces.

3. The decoding method according to claim 1, wherein the non-occupancy region is a region determined to be a region where no object is present in a space including a shape represented by the point cloud data, and the non-occupancy region includes a boundary between a region where no object is present and a region where an object is present.

4. A coding method for encoding point cloud data, the coding method comprising:
repeatedly executing a process of generating an occupancy code until a size of a block becomes a predetermined size, the process being a process in which after a cube including all the point cloud data is divided into eight blocks, an occupancy code represented in an N (1≤N≤8)-ary tree structure is generated by assigning 1 to a divided block including a point and assigning 0 to a divided block including no point, and the block assigned with 1 is further divided;
encoding the occupancy code generated by the repeatedly executing the process; and
outputting the encoded point cloud data, wherein
the repeatedly executing further determines a value of N of the N-ary tree structure for a block to be divided on a basis of an inclusion relation between the block to be divided and a non-occupancy region set in advance.

5. A decoding device for decoding point cloud data from encoded data, the decoding device comprising a processor configured to execute a method comprising:
acquiring an occupancy code represented in an N (1≤N≤8)-ary tree structure by decoding the encoded data;
repeating a process of generating an N-ary tree structure until a block has a predetermined size, the process being a process in which a cube configured to include all the point cloud data is divided into eight blocks and thereafter when a bit of an occupancy code corresponding to a divided block is 1, the block is further divided; and
acquiring, as coordinates of a point in the point cloud data, coordinates of a block of the predetermined size where a bit of an occupancy code corresponding to the block of the predetermined size is 1, wherein
the repeating further determines a value of N of the N-ary tree structure for a block to be divided on a basis of an inclusion relation between the block to be divided and a non-occupancy region set in advance.

6. (canceled)

7. The decoding method according to claim 1, wherein the encoded data is based on an octree structure.

8. The decoding method according to claim 1, wherein the non-occupancy region includes a region where no point is present.

9. The decoding method according to claim 1, wherein the occupancy code includes an 8-bit code, each bit corresponding to a block of the eight blocks in the cube.

10. The decoding method according to claim 2, wherein the non-occupancy region is a region determined to be a region where no object is present in a space including a shape represented by the point cloud data, and the non-occupancy region includes a boundary between a region where no object is present and a region where an object is present.

11. The coding method according to claim 4, wherein the repeatedly executing the process further includes determining, as the N, a number obtained by subtracting from 8 a number of divided regions that are entirely or partially included in the non-occupancy region in eight divided regions obtained by dividing the block to be divided into eight pieces.

12. The coding method according to claim 4, wherein the non-occupancy region is a region determined to be a region where no object is present in a space including a shape represented by the point cloud data, and the non-occupancy region includes a boundary between a region where no object is present and a region where an object is present.

13. The coding method according to claim 4, wherein the encoded point cloud data is based on an octree structure.

14. The coding method according to claim 4, wherein the non-occupancy region includes a region where no point is present.

15. The coding method according to claim 4, wherein the occupancy code includes an 8-bit code, each bit corresponding to a block of the eight blocks in the cube.

16. The coding method according to claim 11, wherein the non-occupancy region is a region determined to be a region where no object is present in a space including a shape represented by the point cloud data, and the non-occupancy region includes a boundary between a region where no object is present and a region where an object is present.

17. The decoding device according to claim 5, wherein the repeating the process further includes determining, as the N, a number obtained by subtracting from 8 a number of divided regions that are entirely or partially included in the non-occupancy region in eight divided regions obtained by dividing the block to be divided into eight pieces.

18. The decoding device according to claim 5, wherein the non-occupancy region is a region determined to be a region where no object is present in a space including a shape represented by the point cloud data, and the non-occupancy region includes a boundary between a region where no object is present and a region where an object is present.

19. The decoding device according to claim 5, wherein the encoded data is based on an octree structure.

20. The decoding device according to claim 5, wherein the non-occupancy region includes a region where no point is present.

21. The decoding device according to claim 5, wherein the occupancy code includes an 8-bit code, each bit corresponding to a block of the eight blocks in the cube.
